(19) United States
(12) Patent Application Publication
(10) Pub. No.: US 2026/0031256 A1
(43) Pub. Date: Jan. 29, 2026

(54) SMALL PACKAGE PTC DEVICE

(71) Applicant: Dongguan Littelfuse Electronics Company Limited, Dongguan City (CN)

(72) Inventors: Jianhua Chen, Dongguan City (CN); Bing Wang, Dongguan City (CN); Minh V. Ngo, Dongguan City (CN)

(73) Assignee: Dongguan Littelfuse Electronics Company Limited, Dongguan City, GD (CN)

(21) Appl. No.: 18/994,247

(22) PCT Filed: Jul. 14, 2023
(86) PCT No.: PCT/CN2023/107409

§ 371 Date: Jan. 14, 2025

(30) Foreign Application Priority Data
Jul. 15, 2022 (CN) 202210835749.2

(51) Int. Cl. H01C 7/02; H01C 1/14

(52) U.S. Cl. CPC H01C 7/02; H01C 1/1406

(57) ABSTRACT

A PTC device includes a protection component and an electrode connected to the protection component. The electrode includes first and second conductive materials. The first conductive material is adjacent the protection component and the second conductive material such that the first conductive material is sandwiched between the two. The first conductive material and the second conductive material prevent solder from touching the protective component.

### FIELD OF THE DISCLOSURE

Embodiments of the present disclosure relate to protection components and, more particularly, to a protection component embedded in a small package.

### BACKGROUND

Positive temperature coefficient (PTC) and polymer PTC (pPTC) devices are protection components utilized in circuits to disrupt overcurrent and overtemperature conditions, therefore protecting circuitry within an electronic system. The PTC device consists of a combination of semi-crystal polymers and conductive fillers which increase resistivity with an increase in temperature. Once the fault condition is removed, the PTC device cools down to its original configuration. The PTC and pPTC are thus thought of as resettable fuses.

The polymers of the PTC device generally include polymer semi-crystalline polymers such as polyethylene, polyvinylidene fluoride, ethylene tetrafluoroethylene, ethylene-vinyl acetate, ethylene and acrylic acid copolymer, ethylene butyl acrylate copolymer, and poly-perfluoroalkoxy. Certain doped ceramics such as barium titanate also exhibit PTC behavior. The conductive fillers in a semi-crystalline polymer cause the resistivity of the PTC thermistor material to increase as the temperature of the material increases. At temperatures below a certain value, the PTC thermistor material exhibits a relatively low, constant resistivity. As the temperature of the PTC thermistor material increases beyond this point, the resistivity increases sharply with only a slight increase in temperature.

Even though the PTC thermistor materials operate at lower resistances under normal conditions, the normal operating resistances for PTC thermistor materials are higher than that of other types of fuses, such as non-resettable metallic fuses. The higher operating resistance results in a higher voltage drop across the PTC thermistor material than for similarly rated non-resettable metallic fuses. Voltage drop and power dissipation are becoming increasingly important to circuit designers who are attempting to maximize the drive capability of a particular circuit as well as battery life.

Package size is also an issue for protection components. Surface mount devices designated by the Electronic Industries Alliance (EIA) are known, such as 0201 (0.6 mm×0.3 mm), are currently available as protection components. A human hair is about 0.18 mm in diameter, so these devices are incredibly small, requiring specialized equipment even for operations such as handling and soldering. The production of the 0201 surface mount devices is challenging. Manufacturing an even smaller protection component is likely to present even more challenges.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a PTC device in accordance with the present disclosure may include a protection component and an electrode connected to the protection component. The electrode includes first and second conductive materials. The first conductive material is adjacent the protection component and the second conductive material such that the first conductive material is sandwiched between the two. The first conductive material and the second conductive material prevent solder from touching the protective component.

Another exemplary embodiment of a PTC device in accordance with the present disclosure may include a protection component and an electrode connected to the protection component. The electrode has four conductive layers arranged in parallel. A first conductive layer and a second conductive layer prevent solder from touching the protective component. A third conductive layer and a fourth conductive layer enable solder to attach to the electrode.

### BRIEF DESCRIPTION OF THE DRAWINGS

FIG. 1 is a diagram illustrating a PTC device, in accordance with exemplary embodiments;

FIG. 2 is a diagram illustrating a PTC device, in accordance with the prior art;

FIGS. 3A-3B are diagrams illustrating surface wettability factors, in accordance with the prior art;

FIGS. 4A-4D are diagrams illustrating device structures of the PTC device of FIG. 1, in accordance with exemplary embodiments;

FIGS. 5A-5D are diagrams illustrating device structures of the PTC device of FIG. 1, in accordance with exemplary embodiments;

FIG. 6 is a table showing options for device structures of the PTC device of FIG. 1, in accordance with exemplary embodiments;

FIG. 7 is a photographic image of a conductive adhesive foil that may be used in manufacturing the PTC device of FIG. 1, in accordance with exemplary embodiments;

FIGS. 8A-8B are diagrams illustrating soldering operations of the PTC device of FIG. 1, in accordance with exemplary embodiments;

FIGS. 9A-9B are microscopic views of the nodular side of the electrodes and the interfaces between the electrodes and the protection material of the PTC device of FIG. 1, respectively, in accordance with exemplary embodiments;

FIGS. 10A-10B are graphs associated with the PTC device of FIG. 1, in accordance with exemplary embodiments;

FIGS. 11A-11D are diagrams associated with the electrodes of the PTC device of FIG. 1, in accordance with exemplary embodiments;

FIGS. 12A-12C are photographic illustrations of a PTC device, in accordance with exemplary embodiments;

FIG. 13 is a flow diagram illustrating operations for manufacturing the PTC device of FIG. 1, in accordance with exemplary embodiments; and

FIGS. 14A-14B are graphs illustrating results of empirical tests performed on a PTC device, in accordance with exemplary embodiments.

### DETAILED DESCRIPTION

A PTC device having a small surface mount form factor is disclosed. The PTC device is quite small, with electrodes surrounding a protection component. The electrodes are strategically layered with conductive materials to ensure high wettability at the bottom of the PTC device, ensuring that the device is solderable and protects against solder getting on the protection component, thus protecting the device against a short-circuit. A variety of design options are available using different conductive materials.

For the sake of convenience and clarity, terms such as “top”, “bottom”, “upper”, “lower”, “vertical”, “horizontal”, “lateral”, “transverse”, “radial”, “inner”, “outer”, “left”, and “right” may be used herein to describe the relative placement and orientation of the features and components, each with respect to the geometry and orientation of other features and components appearing in the perspective, exploded perspective, and cross-sectional views provided herein. Said terminology is not intended to be limiting and includes the words specifically mentioned, derivatives therein, and words of similar import.

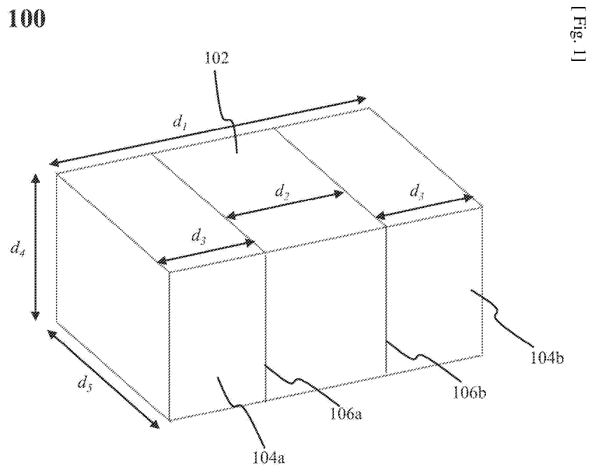

FIG. 1 is a representative drawing of a PTC device 100, according to exemplary embodiments. The PTC device 100 features a protection component 102 sandwiched between two electrodes 104a and 104b (collectively, “electrodes 104”). A first interface 106a is between protection component 102 and electrode 104a while a second interface 106b is between protection component 102 and electrode 104b (collectively, “interfaces 106”). As will be shown herein, in exemplary embodiments, the PTC device 100 is designed to ensure good wetting capability between solder and the electrodes 104. Further, in exemplary embodiments, the interfaces 106 are designed to ensure that the electrodes 104 adhere to the protection component 102. Finally, in exemplary embodiments, the PTC device 100 is designed to prevent a short between the two electrodes 104a and 104b.

In exemplary embodiments, the protection component 102 is a polymeric PTC (pPTC) that provides overcurrent protection, overtemperature protection, and a limited peak current. The PTC material of the protection component 102 may be a PTC conductive composition including a polymer and a conductive filler. The polymer of the PTC material may be a semi-crystalline polymer selected from a group consisting of polyethylene, polyvinylidene fluoride, ethylene tetrafluoroethylene, ethylene-vinyl acetate, ethylene and acrylic acid copolymer, ethylene butyl acrylate copolymer, poly-perfluoroalkoxy, and a mixture thereof. The conductive filler may be dispersed in the polymer and is selected from a group consisting of carbon black, metal powder, conductive ceramic powder, and a mixture thereof. Furthermore, to improve sensitivity and physical properties of the PTC material, the PTC conductive composition may also include an additive such as a photo initiator, a cross-link agent, a coupling agent, a dispersing agent, a stabilizer, an antioxidant, and/or non-conductive anti-arcing filler.

In exemplary embodiments, the PTC device 100 is an Electronic Industries Alliance (EIA) surface mount device, type 01005 having dimensions of 0.4 mm×0.2 mm. In other embodiments, the PTC device is a 008004 device having dimensions of 0.25 mm×0.125 mm. Dimensions d₁, d₂, d₃, d₄, and d₅ are given in the drawings, with dimension d₁ being the length (long side), dimension d₂ being the length of the protection component 102, dimension da being the length of the electrodes 104, dimension d₄ being the height of the PTC device 100, and dimension ds being the width of the PTC device 100. In some embodiments, d₁=0.4 mm, d₂=0.2 mm, d₃=0.1 mm, d₄=0.2 mm, and d₅=0.2 mm. In some embodiments, electrode 104a has the same dimensions as electrode 104b. In a preferred embodiment, the PTC device 100 weighs 0.06 mg.

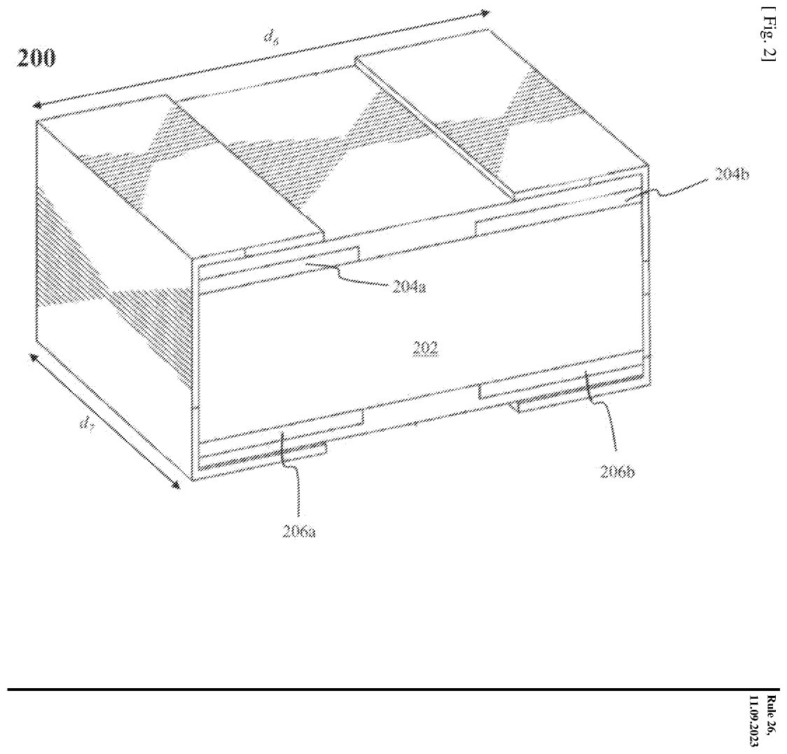

FIG. 2 is a representative drawing of a PTC device 200, according to the prior art. The PTC device 200 features protection component 202 disposed between an electrode having electrode portions 204a and 204b (collectively, “electrode portions 204”) and a second electrode having electrode portions 206a and 206b (collectively, “electrode portions 206”). The PTC device 200 further includes gaps and insulation layers that are not described herein for brevity. The PTC device 200 is an EIA surface mount device, type 0204 with dimensions of 0.6 mm (d₆)×0.3 mm (d₇).

The difference in dimensions between the prior art 0201 PTC device 200 and the 01005 PTC device 100 present challenges. While the prior art PTC device 200 has a length of 0.6 mm, the PTC device 100 has a length of 0.4 mm, with each electrode 104 being a mere 0.1 mm wide. This means that the distance between the two electrodes 104 for the PTC device 100 is only 0.2 mm. Further, in contrast to the PTC device 200, the PTC device 100 includes no insulation material. Despite the short distance between electrodes and lack of insulation material, the PTC device 100 is manufactured to form connections between the protection component 102 and the electrodes 104, ensure that the electrodes are solderable to a printed circuit board (PCB), and prevent shorting between the electrodes 104. The challenge of the microscopic-level device design is to create maximum functionality in a minimum area. As will be shown, every component of the PTC device 100 plays multiple functions.

In exemplary embodiments, the PTC device 100 is designed for both solderability and the prevention of shorting. In order to have good solderability, there must be good wettability. Wettability is the ability of a liquid (e.g., the solder) to maintain contact with a solid surface. Thus, a solder with good wettability can contact both the electrodes 104 of the PTC device 100 and a PCB. A surface can be hydrophobic, which means liquid will roll off its surface, hydrophilic, which means the liquid will form a thin film on the surface, or somewhere in between. For some purposes, having surfaces that are superhydrophobic or super-hydrophilic are preferred.

Two main factors determine the characteristics of a surface: surface chemistry and surface roughness. A surface with low surface energy, such as plastics, tends to be hydrophobic while a surface with high surface energy, such as metals, tends to be hydrophilic. Surface roughness generally will make a hydrophobic surface even more hydrophobic and a hydrophilic surface even more hydrophilic.

Surfaces are characterized as being hydrophobic or hydrophilic by measuring a contact angle. The contact angle is an angle formed by a liquid at the three-phase boundary where a liquid, gas (vapor), and solid intersect. Contact angle gives an indication about how well or poorly a liquid will spread over a surface, and thus its wettability. If the contact angle is greater than 90°, the surface is hydrophobic while a contact angle less than 90° means that the surface is hydrophilic.

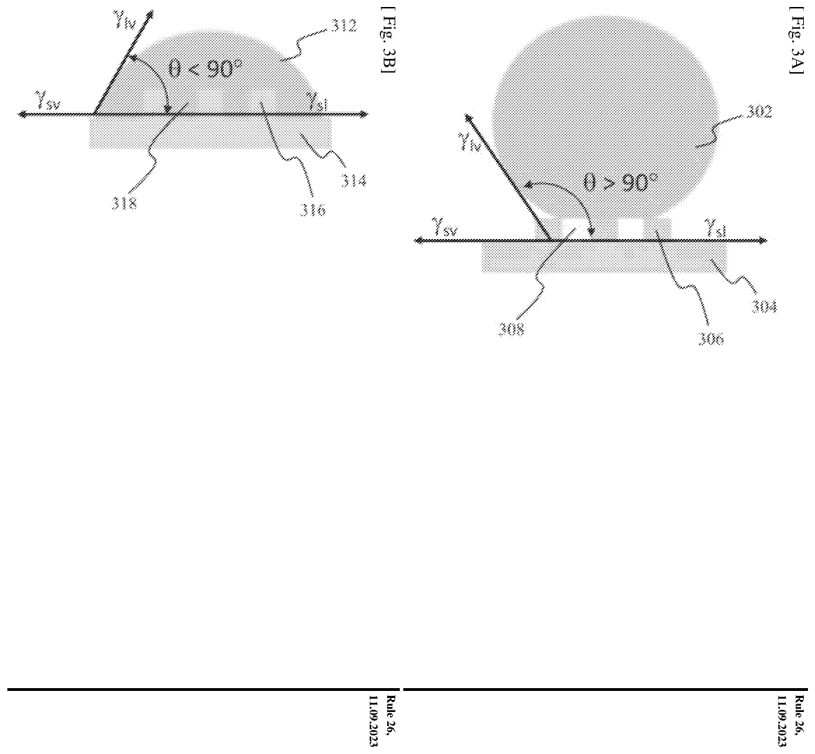

FIGS. 3A and 3B are representative drawings illustrating wettability principles, according to the prior art. FIG. 3A shows a liquid 302 disposed on a surface 304, with the surface having some rough structures 306. Line γ, is the interface between the solid surface 304 and the liquid 302; line γₛᵥ is the interface between the solid surface 304 and air (vapor); and line γₗᵥ is the interface between the liquid 302 and the air. The contact angle, θ, calculated between the solid-liquid interface γₛₗ and the liquid-vapor interface γₗᵥ is greater than 90°. Known as the Cassie-Baxter Model, the surface 304 is hydrophobic. The rough surface 304 is not penetrable by the liquid droplet 302. The liquid 302 rests on top of the rough structures 306 of surface 304 but does not occupy the spaces 308 between the roughness 306. Air is thus trapped between the rough structures 306 in the spaces. Surfaces having contact angles greater than 90° are the least wettable. A surface characterized as in FIG. 3A is known as having a lotus effect, named for the tendency of water droplets to wash over the surface of the lotus leaf. FIG. 3B shows another liquid 312 disposed on a surface 314, with the surface having some rough structures 316. Line γₛₗ is the interface between the solid surface 314 and the liquid 312; line γₛᵥ is the interface between the solid surface 314 and air (vapor); and line γₗᵥ is the interface between the liquid 312 and the air. The contact angle, θ, calculated between the solid-liquid interface γₛₗ and the liquid-vapor interface γₗᵥ is less than 90°. Known as the Wenzel Model, the surface 304 is hydrophilic. The liquid droplets 312 penetrate the rough structures 316, fitting into the spaces 318 between the rough structures 316 on the surface 314, leading to high adhesive forces.

The electrodes 104 of the PTC device 100 are designed to be hydrophilic so ensure high wettability and thus good soldering results. Simultaneously, the electrodes 104 are designed to prevent shorting from occurring. In exemplary embodiments, these two objectives are achieved by designing the electrodes 104 with distinct strips or portions, each strip being potentially made using a different material.

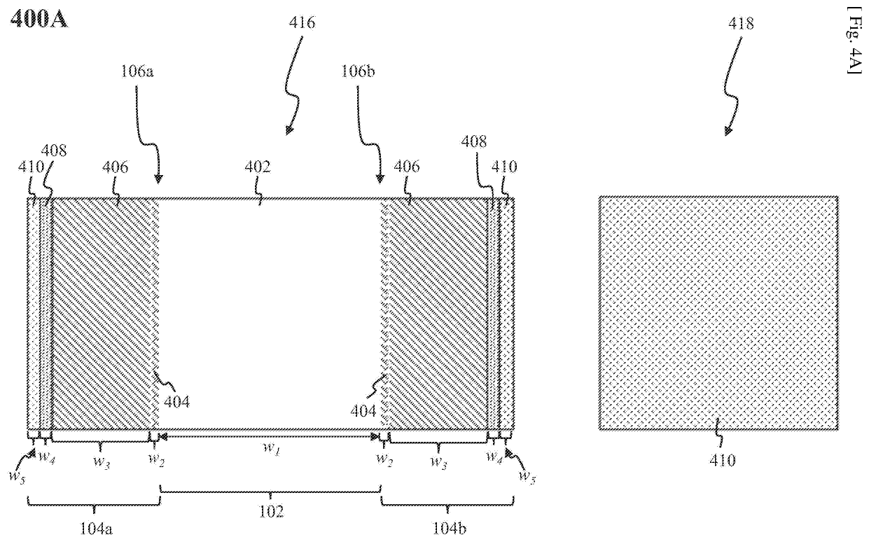

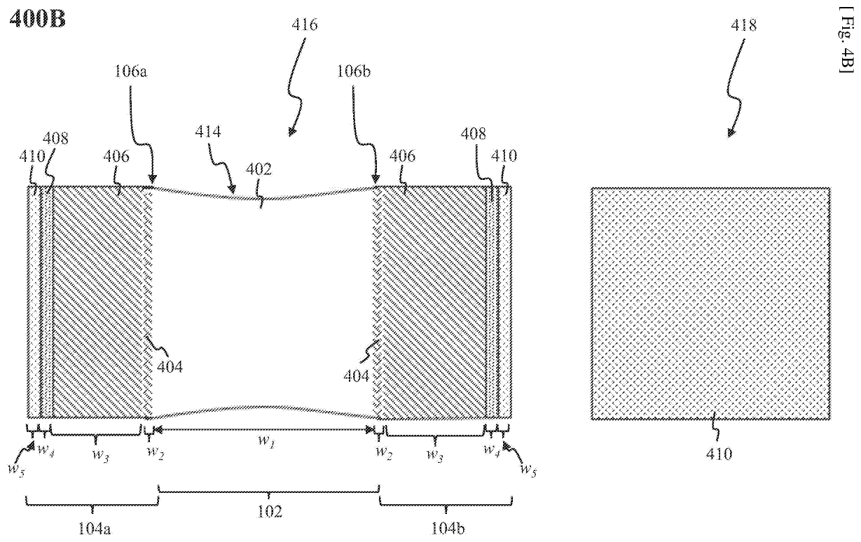

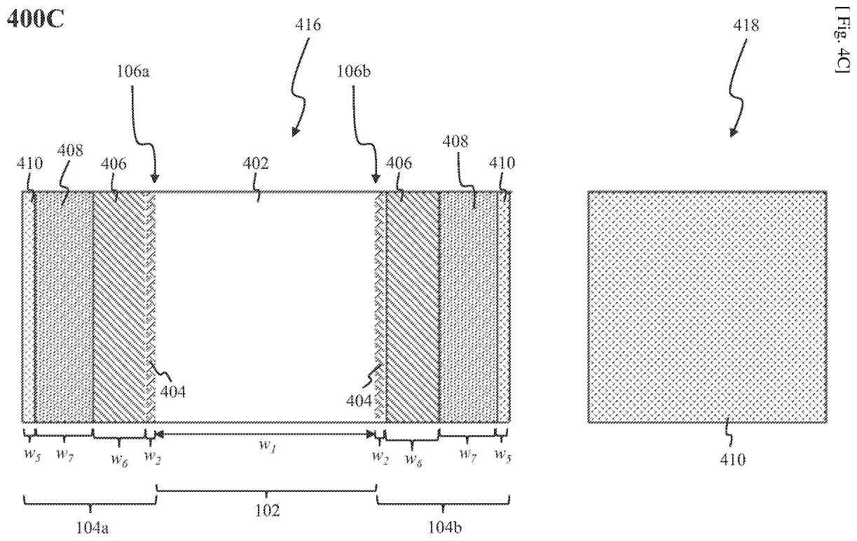

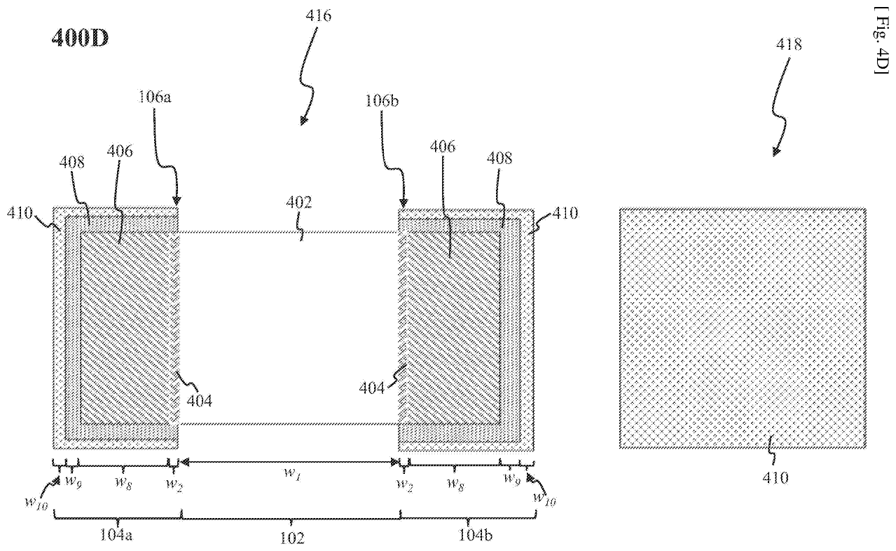

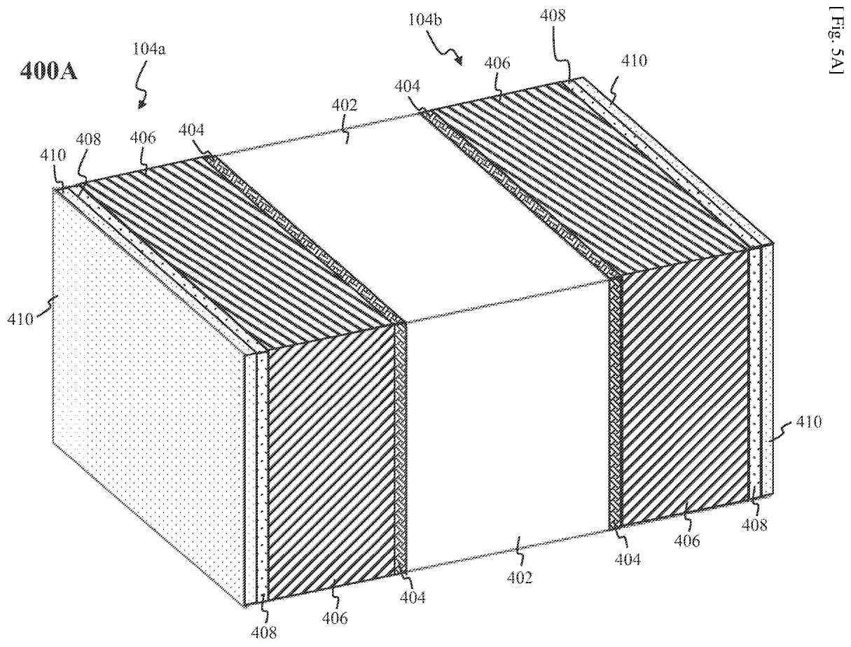

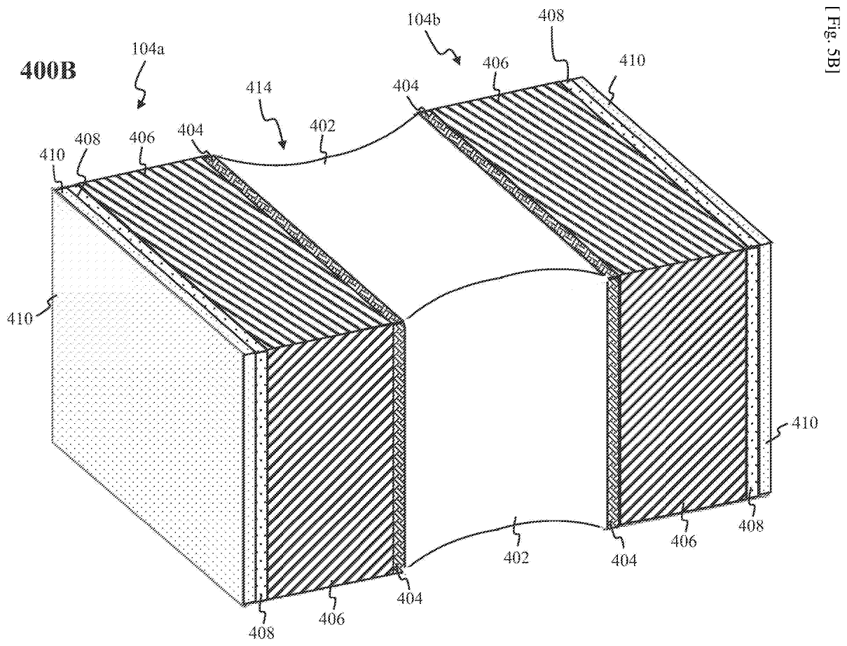

FIGS. 4A-4D are representative drawings of pPTC device structures used in manufacturing the PTC device 100, according to exemplary embodiments. FIG. 4A features pPTC device structure 400A; FIG. 4B features pPTC device structure 400B; FIG. 4C features pPTC device structure 400C; and FIG. 4D features pPTC device structure 400D (collectively, “pPTC device structure(s) 400”). Top views 416 and side views 418 of the PTC device 100 are part of each pPTC device structure 400. The protection component 102, electrodes 104, and interfaces 106 introduced in FIG. 1 are indicated at the bottom of each pPTC device structure 400. The pPTC device structures 400 may be viewed in conjunction with the perspective views of pPTC device structures 400A-400D in FIGS. 5A-5D as well as the table of FIG. 6, which shows fourteen non-limiting design options for the pPTC device structures 400, including materials that may be used for each strip of the electrodes 104.

The protection component 102 for each pPTC device structure includes pPTC material 402, which, in a non-limiting example, features various polymers, conductive materials, and additives. In exemplary embodiments, the electrodes 104 feature multiple, distinct strips of conductive materials, with particular attention paid to the interfaces 106 between respective electrodes 104 and the protection component 102.

In the pPTC device structure 400A (FIG. 4A), electrode 104a consists of four distinct conductive materials 404, 406, 408, and 410, and electrode 104b consists of the same four conductive materials 404, 406, 408, and 410, which may also be known as conductive layers, since the conductive materials are arranged in parallel layers. In describing electrode 104a, note that electrode 104b is similarly configured. Conductive material 404 is at the interface 106a between electrode 104a and protection component 102 consisting of pPTC material 402. In exemplary embodiments, the conductive material 404 adjacent the pPTC material 402 consists of one or more of nickel (Ni), nickel phosphorus (NiP), copper (Cu), and a conductive adhesive, including alloys or other combinations of these materials. These materials happen to be corrosion resistant materials. Conductive material 404 is thus the first “strip” of the electrode 104a adjacent the pPTC 402.

Adjacent the conductive material 404 is conductive material 406, such that conductive material is sandwiched between pPTC material 402 and conductive material 404. In exemplary embodiments, conductive material 406 consists of one or more of nickel, copper, and nickel chromium (NiCr), including alloys or other combinations of these materials.

In exemplary embodiments, the rough surface of the conductive materials 406 protect the pPTC material 402 from being touched by the solder, which would short out the PTC device 100. In exemplary embodiments, a nodular foil is used for conductive materials 404 and/or 406, with one side of the nodular foil being conductive material 404 and the other side of the nodular foil being conductive material 406, resulting in a nodular electrode. The nodular electrode has a shiny (smooth) side and a nodular (bumpier/rougher) side. In exemplary embodiments, the conductive material 404 (nearest the pPTC material 402) is the nodular side of the nodular foil while the conductive material 408 is the shiny side of the nodular electrode.

The nodular surface can thus be manufactured to provide connection between the pPTC and electrodes. The nodular side of the nodular electrode (conductive material 404) can have one or more of nickel, copper, and a nickel phosphorus metal alloy thereon. In exemplary embodiments, the one or more corrosion resistant elements or alloys of the conductive material 404 are electrodeposited onto one side of the nodular foil (the nodular side) while one or more foil materials, such as nickel, copper, and nickel-chromium alloy of the conductive material 406 are deposited onto the other side of the nodular electrode (the shiny side).

Alternatively, in exemplary embodiments, a conductive adhesive foil is used for conductive materials 404 and 406, with one side of the conductive adhesive foil already having copper or nickel on one side, and conductive adhesive on the other. Since nickel and copper are two preferred elements of the conductive material 404, the other side of the conductive adhesive foil can have nickel, copper, and/or nickel phosphorus metal alloy electrodeposited thereon.

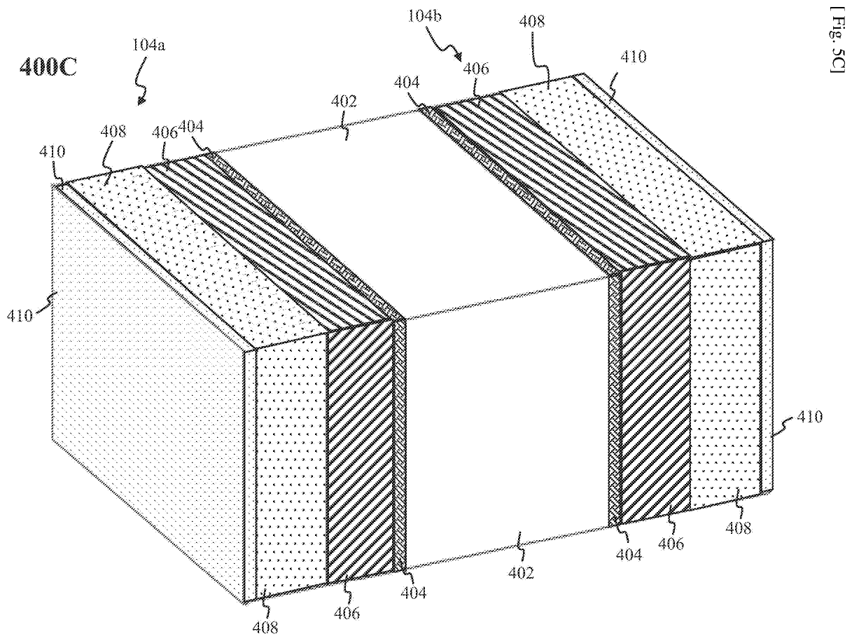

FIG. 7 is a photograph of conductive adhesive foil 700 that can be used as a starter material for generating the conductive materials 404 and 406 to be used for the electrodes 104 of the PTC device 100. The conductive adhesive foil 700 features metal foil 706 on one side, conductive adhesive 702 on the other side, with a paper 704 disposed between layers. The pPTC device structure on the right shows that the conductive adhesive 702 can be placed adjacent the protection material 402, such that the conductive material 404 is the conductive adhesive 702 and the metal foil 706 is part of the conductive material 406.

Thus, the conductive materials 404 and 406 of the electrodes 104 are manufactured to ensure that no shorting happens between electrode 104a and electrode 104b. Put another way, the conductive materials 404 and 406 are selected to ensure that solder does not reach the pPTC material 402 of the PTC device 100. By contrast, in exemplary embodiment, the conductive materials 408 and 410 of the electrodes 104 are manufactured to ensure that the electrodes 104 are hydrophilic, that is, sufficiently wettable to ensure that the liquid solder penetrates the rough structures of the electrodes 104, ensuring a good solder connection between the electrode and the PCB to which the PTC device 100 is attached.

Returning to FIG. 4A, for each electrode 104, adjacent the conductive material 406 is conductive material 408, such that conductive material 406 is sandwiched between conductive material 404 and conductive material 408. In exemplary embodiments, conductive material 408 consists of one or more of nickel, silver-plated nickel, and nickel palladium alloy (Ni/Pd). Adjacent the conductive material 408 is conductive material 410 such that conductive material 408 is sandwiched between conductive material 406 and conductive material 410, and the conductive material 410 is at the outer edge of the electrode 104. In exemplary embodiments, conductive material 410 consists of one or more of gold (Au) and tin, including alloys or other combinations of these materials, such as a thick tin.

The conductive materials 408 and 410 are designed for better solderability, to ensure a good coupling of solder to the electrodes 104. In exemplary embodiments, conductive material 408 is designed with conductive material 410 in mind, and vice-versa. The use of gold in the outer conductive material 410 prevents oxidation of nickel in conductive material 408. The use of tin in the outer conductive material 410 increases the solderability of the electrodes 104. The use of nickel or nickel palladium in conductive material 408 prevents tin whiskers and migration from occurring in conductive material 410. Together, the conducting materials 408 and 410 provide sufficient wetting to ensure a good solder of the PTC device 100.

FIGS. 4B-4D present alternative pPTC device structures 400B, 400C, and 400D, in exemplary embodiments. The pPTC device structure 400B in FIG. 4B is somewhat like the pPTC device structure 400A (FIG. 4A). The electrodes 104 contain the same arrangement of strips of conductive material 404, 406, 408, and 410, for example. However, the protection component 102 consisting of pPTC material 402 is shaped differently than for pPTC device structure 400A. In exemplary embodiments, there is a curve 414 at the edges of the protection component 102. Thus, while edges of the electrodes 104a and 104b are planar to one another, the protection component 102 is indented slightly and therefore its edges are not planar to the edges of the electrodes 104. The result is a slight decrease in volume of the pPTC material 402. Further, by having the pPTC material 402 be slightly thinner at the edges than the electrodes 104, there is less chance the solder will touch the pPTC material 402, thus making a short between electrodes 104 less likely to occur, in some embodiments.

For the pPTC device structures 400A and 400B, the widths of the strips of conductive materials 404, 406, 408, 410 and pPTC material 402. While pPTC material 402 has width, w₁, conductive material 404 has width, w₂, conductive material 406 has width, w₃, conductive material 408 has width, w₄, and conductive material 410 has width, w₅. In exemplary embodiments, conductive materials 404, 408, and 410 are similar in width, with conductive material 404 at the interface 106a being the least wide while the width of conductive material 406 is significantly wider than the other strips of conductive material. Further, the pPTC material 402 is wider than the strips of conductive material. Stated mathematically, w₁>w₃>w₄≅w₅>w₂, although these relative widths are not meant to be limiting.

The pPTC device structure 400C in FIG. 4C is like the pPTC device structures 400A (FIG. 4A) and 400B (FIG. 4B), with some differences. The arrangement of conductive materials in each electrode 104 has not changed, with conductive material 404 being adjacent to pPTC material 402, conductive material 406 being adjacent to conductive material 404, conductive material 408 being adjacent to conductive material 406, and conductive material 410 being adjacent to conductive material 408 in each electrode 104. The protection component 102 consists of pPTC material 402 of width, w₁, with conductive material 404 of width, w₂, being on either side of the pPTC material 402, as before. Further, conductive material 412 of width, w₅, is disposed at the ends of the electrodes 104 of pPTC device structure 400C, distal to the pPTC material 402, as before.

The widths of conductive materials 406 and 408 are different, however, for the pPTC device structure 400C. In exemplary embodiments, conductive material 406 has a width, w₆, and conductive material 408 has a width, w₇. In some embodiments, these two widths are similar and are wider than conductive materials 404 and 410, but not wider than the pPTC material 402. Stated mathematically, w₁>w₆≅w₇>w₅>w₂, although these relative widths are not meant to be limiting. In exemplary embodiments, the pPTC device structure 400C over pPTC device structures 400A and 400B because the thicker conductive material 408 increases solderability of the PTC device 100.

The pPTC device structure 400D in FIG. 4D is somewhat different than the pPTC device structures 400A, 400B, and 400C. While conductive materials 404 and 406 are similar in that they are strips, the conductive materials 408 and 410 wrap around the electrodes 104, in exemplary embodiments. In some embodiments, the width of conductive material 404, w₂, is like that of the other pPTC device structures, 400A, 400B, 400C, while the width of conductive material 406, w₈, is wider. Conductive material 408, having width, w₉, extends around three sides of the conductive materials 404 and 406 while conductive material 410, having width, w₁₀, is adjacent to the three sides of conductive material 408. In the top view 416, the conductive materials 404 and 406 are still able to protect against solder reaching the pPTC material 402, while the conductive materials 408 and 410 area able to ensure that the electrodes 104 are wettable enough to accept the solder.

The perspective views of respective pPTC device structures 400A-D in FIGS. 5A-D show that the conductive material 404 is a layer adjacent the pPTC material 402, the conductive material 406 is a layer that runs adjacent and parallel to the conductive material 404; the conductive material 408 is a layer that runs adjacent and parallel to the conductive material 406; and the conductive material 410 is a layer that runs adjacent and parallel to the conductive material. In exemplary embodiments, the pPTC device structures 400D (FIGS. 4D and 5D) have five surfaces covered with conductive material 408 and 410.

Sides of the PTC device 100 consist of the conductive material 410 (e.g., tin, gold, gold-plated tin). In exemplary embodiments, by having conductive material 410 along the sides of the pPTC device structures 400, the wettability of the electrodes 104 is high enough to ensure a good attachment to the solder. In particular, FIG. 4D shows that, despite the conductive materials 408 and 410 enveloping the conductive materials 404 and 406, conductive material 404 is still adjacent the pPTC material 402 and therefore the pairing of conductive materials 404 and 406 can prevent short-circuiting of the PTC device 100 by preventing solder from reaching the pPTC material 402.

The table of FIG. 6 shows different design options that can result from the pPTC device structures 400, according to exemplary embodiments. In exemplary embodiments, conductive material 404 is used for corrosion resistance while conductive material 406 is a base electrode, with its side surfaces being roughened during processing to limit the solder flow on the rough surface on the top of the device. The conductive material 406 is thus designed to ensure that a short-circuit between electrodes 104 of the PTC device 100 is avoided. The nickel found in conductive material 408 serves as a barrier layer between tin and copper to prevent the dissolution of the copper, and further retards the excess growth of copper/tin intermetallic compounds (IMCs), in exemplary embodiments. The nickel layer also can prevent rapid reaction between the solder and copper layers on the PCB and provides a flat and uniform surface, in exemplary embodiments. Applied together with gold, the nickel ensures good wettability of the electrodes 104, even after multiple reflows. Further, while the conductive material 404 does not include copper in some of the design options, conductive material 406 will include copper, although the copper lacks the corrosion resistance of nickel. Where conductive material 410 includes tin, conductive material 408 will include nickel to avoid copper/tin IMCs from developing. Nickel is also selected in one or more conductive materials to improve corrosion resistance and, where used, the nickel may be gold-plated to prevent oxidation of the nickel. In exemplary embodiments, the electrodes 104 of the PTC device 100 are made, at bare minimum, with some combination of tin, nickel, and copper or tin, nickel, and silver. There are thus many different options for the design of the electrodes 104 of the PTC device 100. Although fourteen different design options are shown in the table of FIG. 6, the PTC device 100 may be designed with many more combinations of the four conductive materials 404, 406, 408, and 410 than are shown.

In exemplary embodiments, the PTC device 100 is designed with optimum wetting capability at the bottom but not the top of the device. This ensures good solder connection at the bottom but mitigates the possibility of solder getting onto the pPTC material 402. In the perspective views of the pPTC device structures 400, the sides of the electrodes 104 are made using conductive material 410, which may be tin, gold, thick tin, and gold-plated tin. Recall that tin provides good wetting of the electrodes 104. Thus, application of the solder to the PTC device 100 may focus on the sides/bottom of the device rather than the top. In the pPTC device structure 400D (FIG. 5D), the conductive material 410 surrounds the surfaces of the electrodes 104 such that the conductive material 410 is both parallel to the conductive material 404 (or conductive material 406 or conductive material 408) and orthogonal to the conductive materials 404, 406, or 408. Thus, a highly wettable surface is available for soldering the PTC device 100 to a PCB.

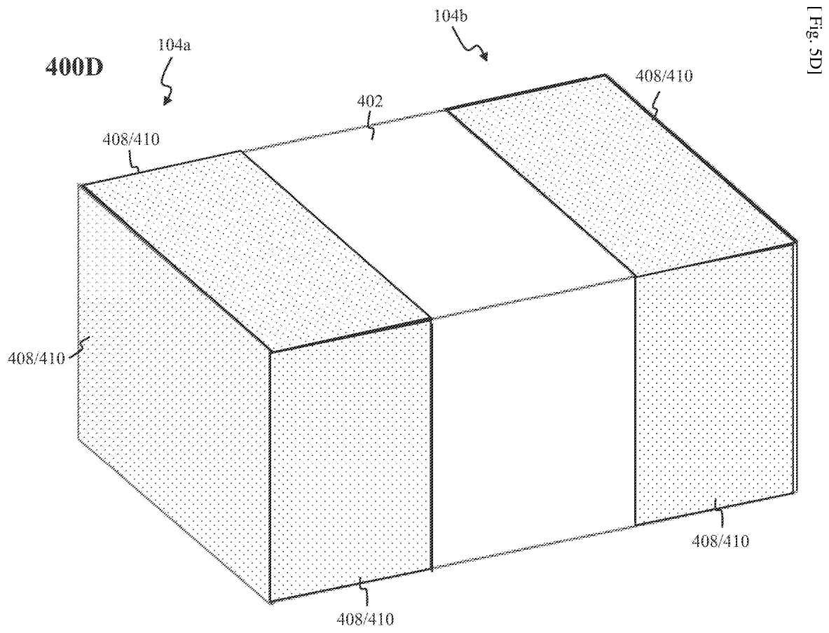

FIGS. 8A-8B are representative drawings contrasting the effect of solder placement on the PTC device 100, according to exemplary embodiments. In FIG. 8A, a PTC device 802 features a protection component 804, such as pPTC, and electrodes 806a and 806b (collectively, “electrodes 806”), much like the PTC device 100. The PTC device 802 is seated on pads 808a and 808b (collectively, “pads 808”), with solder 810a and 810b (collectively, “solder 810”) being used to attach the electrodes 806 to respective pads 808. In exemplary embodiments, the electrodes 806 are designed for maximum wetting so that the solder 810 attaches the electrodes 806 to the pads 808. However, the solder 810 extends too far across the electrodes 806 such that the solder 810 may reach the protection component 804. This will cause a short between the two electrodes 806, which will destroy the PTC device 802. In exemplary embodiments, the conductive materials 404 and 406 are designed to protect the PTC device 100 from the short-circuit experienced by the PTC device 802.

In exemplary embodiments, in addition to being designed for maximum wetting, the electrodes 806 are also designed so that the solder 810 does not touch the protection component 804. In FIG. 8B, a PTC device 812 features a protection component 814 and electrodes 816a and 816b (collectively, “electrodes 816”), much like the PTC device 100. The PTC device 812 is seated on pads 818a and 818b (collectively, “pads 818”), with solder 820a and 820b (collectively, “solder 820”) being used to attach the electrodes 816 to respective pads 818. In exemplary embodiments, the electrodes 816 are designed for maximum wetting so that the solder 820 attaches the electrodes 816 to the pads 818. Further, in exemplary embodiments, the solder 820 is limited to the bottom of the PTC device 812. In the PTC device 100, conductive materials 408 and 410 facilitate the disposition of the solder at the bottom of the PTC device 100. Additionally, in exemplary embodiments, the electrodes 816 are designed to discourage the solder 820 from getting near the protection component 814. In the PTC device 100, conductive materials 404 and 406 facilitate the disposition of solder so that the solder does not get near the pPTC material 402 that is disposed between the electrodes 104.

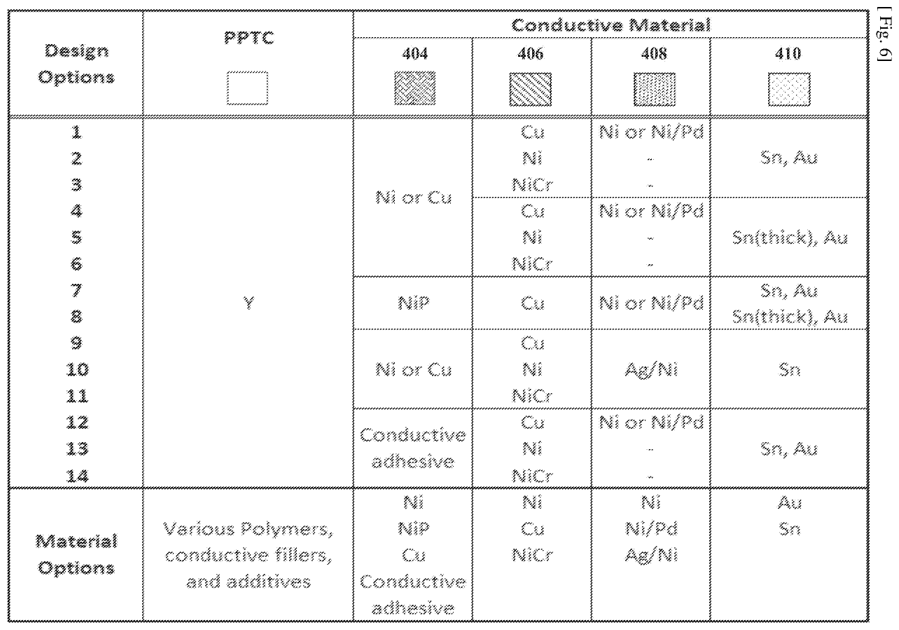

FIGS. 9A-9B are representative microscopic views of these interfaces 106, according to exemplary embodiments. FIG. 9A is a microscopic image of an electrodeposited copper nodular foil which, in exemplary embodiments, is a corrosion resistant material with a low copper concentration and high current density. In exemplary embodiments, the nodules are between 0.9 and 1.43 kg/cm. In exemplary embodiments, the electrodeposited copper nodular foil is used as the conductive material 404 that is disposed at the interfaces 106. FIG. 9B shows the shiny side 902 and nodular side 904 of a nodular foil. Recall that the conductive material 404 and the conductive material 406 are made from a nodular electrode, in some embodiments. In this example, the nodular electrode has a height of approximately 44 μm. The Ra parameter is a roughness average of a surface measured.

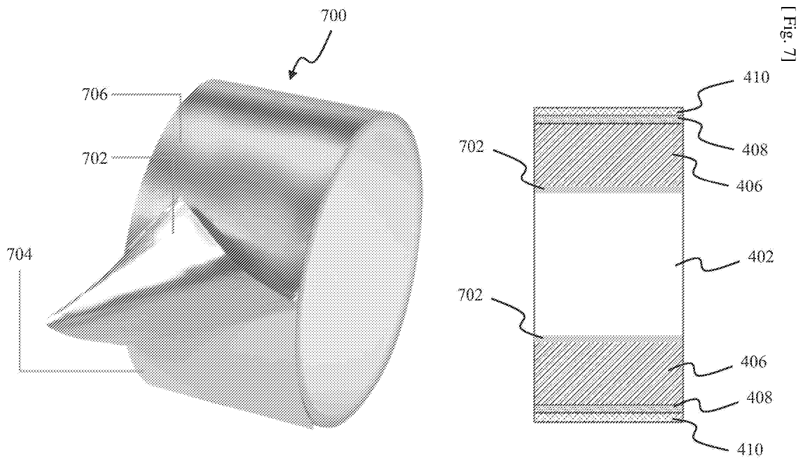

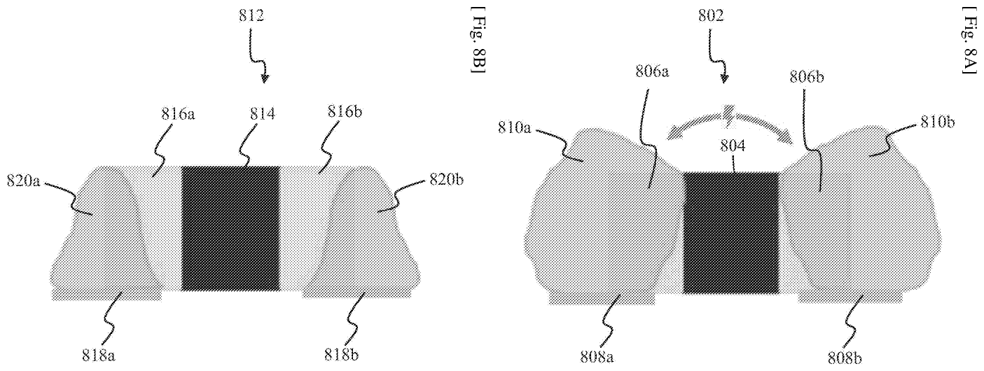

FIGS. 10A-10B are representative graphs associated with the PTC device 100, according to exemplary embodiments. FIG. 10A plots readings versus the peel force (in pounds) of the electrodeposited copper nodular foil. FIG. 10B plots a diagram of a sample length (in μm) versus height (in μm) for the electrodeposited copper nodular foil, where the Ra parameter is again shown. FIG. 10B also shows the definition of Ra and the calculation equation for the roughness average of a measured surface.

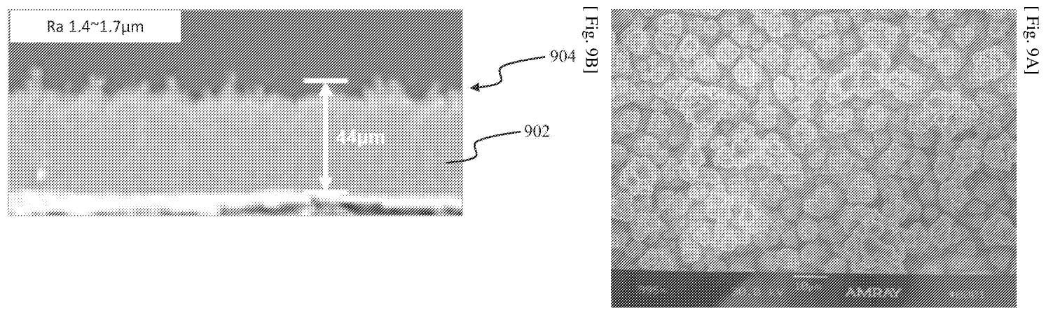

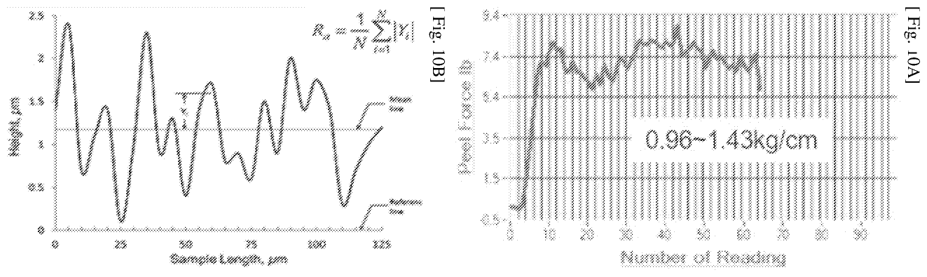

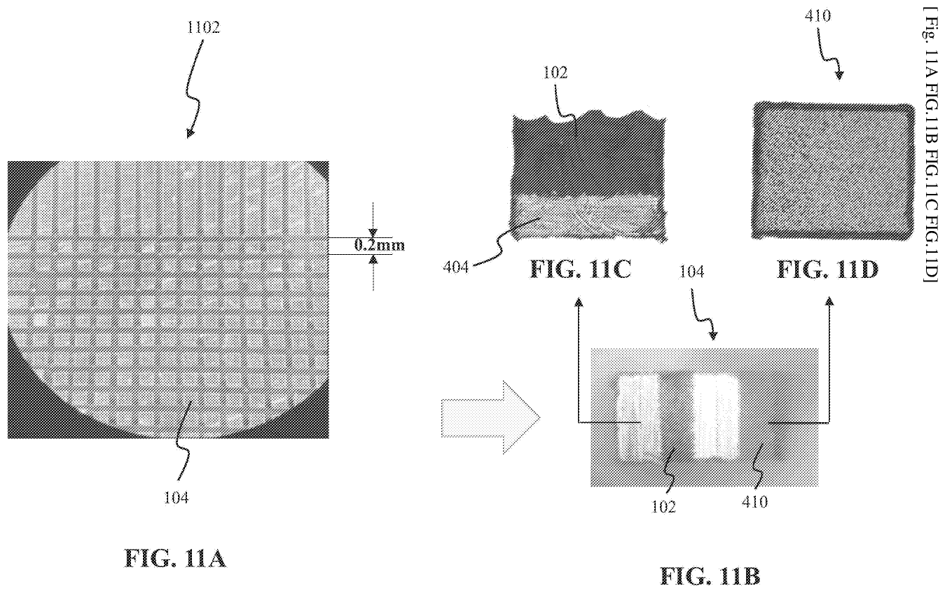

FIGS. 11A-11D are representative images of parts of the PTC device 100, according to exemplary embodiments, with FIG. 11A featuring the wafer of electrodes and FIGS. 11B-D showing the 01005 devices after separation. The images show the processing challenges faced with manufacturing the PTC device 100. FIG. 11A shows a wafer 1102 featuring an array of electrodes 104, where the electrodes 104 are part of the PCT device 100; FIG. 11B is an overhead view of the electrode 104, adjacent protection component 102; FIG. 11C is an overhead view of the interface between the end layer of the electrode 104 and the protection component 102 of the PTC device 100; and FIG. 11D is a side view of the electrode 104. Recall from FIG. 1 that the electrodes 104 of the PTC device 100 have dimensions of 0.1 mm (d₃)×0.2 mm (d₄)×0.2 mm (d₅). The electrodes 104 are thus very, very small rectangular cubes. The formation of the electrodes 104, such as is illustrated in the pPTC device structures 400 (FIGS. 4A-4D and 5A-5D) is thus not trivial. FIG. 11B shows that the electrode 104 is made up of up to four layers/slices of conductive material, with multiple design options available for the PTC device 100, as in the table of FIG. 6. The thicknesses and compositions of each layer/slice may vary. The conductive material 404 adjacent to the protection component 102 is shown in FIG. 11C.

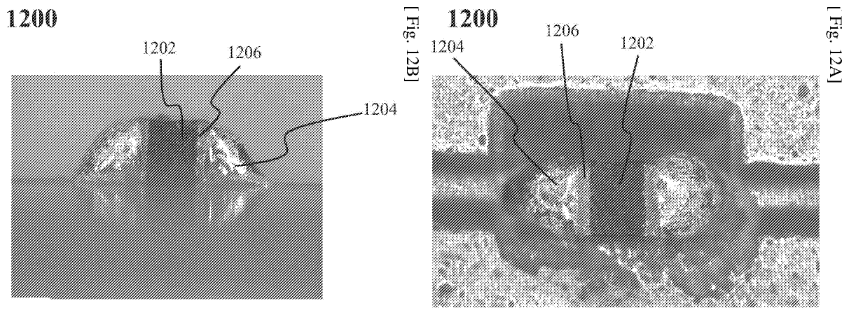

FIGS. 12A-12C are representative photographic images of a PTC device 1200, according to exemplary embodiments. The PTC device 1200 may be like PTC device 100. FIG. 12A is an overhead view, FIG. 12B is a side view, and FIG. 12C is a perspective view of the PTC device 1200. The PTC device 1200 includes a protection component 1202 surrounded by electrodes. In the images, the electrodes are covered with solder 1204 and thus not visible, except for a single electrode layer 1206, which is adjacent the protection component 1202 on either side. In exemplary embodiments, the electrode layer 1206 protects the protection component 1202 by keeping the solder 1204 from reaching the protection component 1202. Further, as particularly shown in FIG. 12B, the solder 1204 is more prominent at the bottom of the PTC device 1200 than on the top. This is evidence of good wetting between the solder 1204 and the underlying electrode. FIG. 12C shows the PTC device 1200 without solder, with the protection component 1202 surrounded by electrodes 1208.

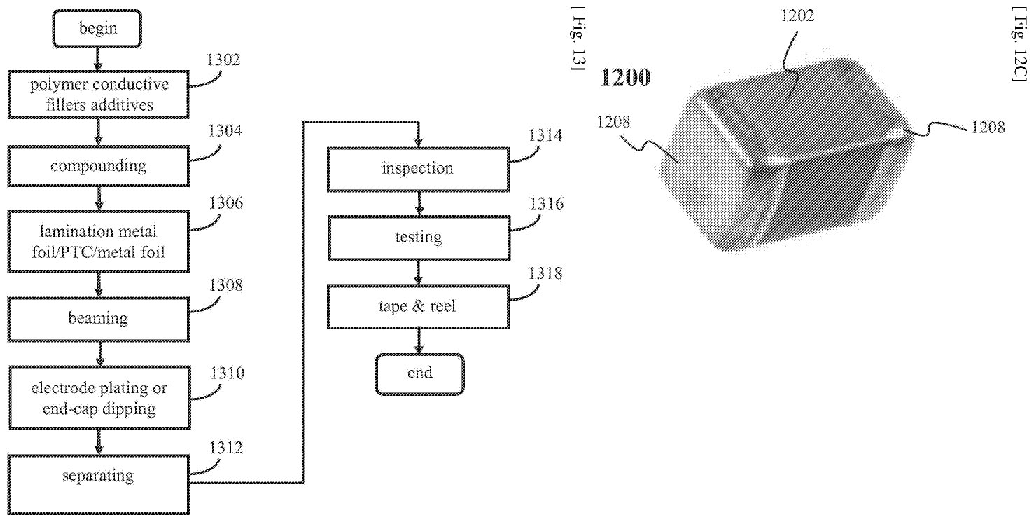

FIG. 13 is a flow diagram showing the process flow for manufacturing the PTC device 100, according to exemplary embodiments. The protection component is created, made up of polymer, conductive fillers, and additives (block 1302). Compounding is then performed (block 1304). A lamination of metal foil, PTC, and metal foil is made (block 1306). A beaming or crosslinking operation is performed (block 1308), then electrode plating or end-cap dipping is performed (block 1310). Next, a separating operation is performed, which may include dicing, shearing, or laser cutting, as non-limiting examples (block 1312). An inspection is performed (block 1314), followed by testing (block 1316) and finally the PTC devices are set up for tape and reel (block 1318).

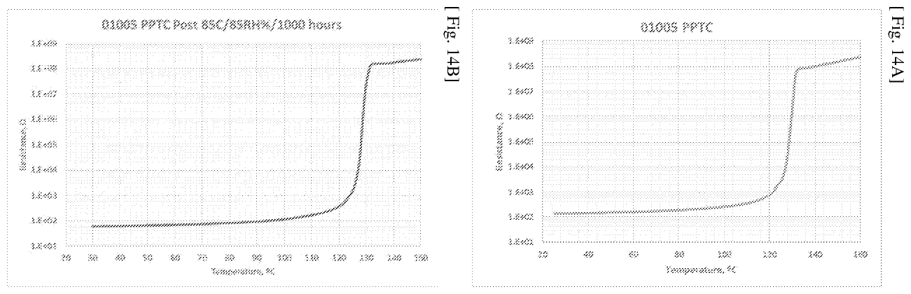

FIGS. 14A and 14B are graphs showing performance of a PTC device, such as the PTC device 100, according to exemplary embodiments. FIG. 14A shows the resistance versus temperature before aging while FIG. 14B shows the resistance versus temperature after aging (85° C., 85% relative humidity, 1000 hours). FIG. 14B shows that there is not a significant diminution in performance of the PTC device after aging.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A positive temperature coefficient (PTC) device comprising:
a protection component; and
an electrode coupled to a first side of the protection component, the electrode comprising:
a first conductive material disposed adjacent the protection component, wherein the first conductive material is a nodular side of a nodular foil;
a second conductive material disposed adjacent the first conductive material, the first conductive material being sandwiched between the protection component and the second conductive material, the second conductive material being a shiny side of the nodular foil, wherein the first conductive material and the second conductive material prevent solder from touching the protection component.

2. The PTC device of claim 1, the electrode further comprising:
a third conductive material disposed adjacent the second conductive material, wherein the second conductive material is sandwiched between the first conductive material and the third conductive material; and
a fourth conductive material disposed adjacent the third conductive material, wherein the third conductive material is sandwiched between the second conductive material and the fourth conductive material.

3. The PTC device of claim 2, wherein the third conductive material and the fourth conductive material make the electrode hydrophilic.

4. The PTC device of claim 3, wherein the fourth conductive material is further disposed along a side orthogonal to the first conductive material.

5. The PTC device of claim 2, wherein the first conductive material is a first layer and the second conductive layer is a second layer, the first layer being parallel to the second layer.

6. The PTC device of claim 5, wherein the first layer is thinner than the second layer.

7. The PTC device of claim 5, wherein the third conductive material is a third layer and the fourth conductive material is a fourth layer, the third layer being parallel to the fourth layer.

8. The PTC device of claim 7, wherein the second layer is thicker than the first layer, the third layer, and the fourth layer.

9. The PTC device of claim 1, wherein the first layer is selected from a group consisting of nickel, copper, nickel phosphorus, conductive adhesive, and alloys of nickel, copper, and nickel phosphorus.

10. The PTC device of claim 1, wherein the second layer is selected from a group consisting of copper, nickel, and nickel chromium.

11. The PTC device of claim 2, wherein the third layer is selected from a group consisting of nickel, nickel palladium, and silver-plated nickel.

12. The PTC device of claim 2, wherein the fourth layer is selected from a group consisting of tin, silver, thick tin, and gold.

13. The PTC device of claim 1, wherein the protection component is curved at its edges.

14. The PTC device of claim 2, wherein the second conductive material and the third conductive material are approximately the same width.

15. The PTC device of claim 1, further comprising a second electrode coupled to a second side of the protection component, the second side being opposite the first side.

16. A positive temperature coefficient (PTC) device comprising:
a protection component; and
an electrode coupled to the protection component, the electrode comprising four conductive layers arranged in parallel, the four conductive layers comprising:
a first conductive layer comprising a nodular surface and a second conductive layer comprising a shiny surface, wherein the first conductive layer and the second conductive layer prevent solder from touching the protection component; and
a third conductive layer and a fourth conductive layer, wherein the third conductive layer and the fourth conductive layer enable solder to attach to the electrode.

17. The PTC device of claim 16, wherein the nodular surface and the shiny surface are two surfaces of a nodular foil.

18. The PTC device of claim 16, wherein the electrode measures 0.1 mm×0.2 mm×0.2 mm.

19. The PTC device of claim 16, wherein either the first conductive layer or the second conductive layer contain copper.

20. The PTC device of claim 16, wherein the fourth conductive layer contains tin, gold, or a combination of tin and gold.
